(19) United States
(12) Patent Application Publication
(10) Pub. No.: US 2025/0323366 A1
(43) Pub. Date: Oct. 16, 2025

(54) BATTERY SYSTEM WITH IMPROVED END SPACER

(71) Applicant: SAMSUNG SDI CO., LTD., Yongin-si (KR)

(72) Inventor: Martin BLODER, Sinabelkirchen (AT)

(21) Appl. No.: 18/886,506

(22) Filed: Sep. 16, 2024

(30) Foreign Application Priority Data
Apr. 10, 2024 (EP) 24169461.1

(51) Int. Cl. H01M 50/242; B60L 50/64; H01M 50/209; H01M 50/211; H01M 50/291; H01M 50/293

(52) U.S. Cl. CPC H01M 50/242; B60L 50/64; H01M 50/209; H01M 50/211; H01M 50/291; H01M 50/293; H01M 2220/20

(57) ABSTRACT

A battery system includes: a cell stack including a plurality of arranged battery cells; and a cell stack frame accommodating the cell stack; and a deformable end spacer. The cell stack frame includes an end plate exerting pressure onto the cell stack, and the deformable end space is arranged between the cell stack and the end plate to be compressed by the pressure exerted by the end plate. The deformable end spacer includes: parallel plate elements; and a metal foam and/or a metal honeycomb structure arranged between the plate elements. The plate elements have a different material composition than the metal foam and/or the metal honeycomb structure, the metal foam is an aluminum foam and/or the metal honeycomb structure is an aluminum honeycomb structure, and the plate elements are steel plate elements.

### CROSS REFERENCE TO RELATED APPLICATION

The present application claims priority to and the benefit of European Patent Application No. 24169461.1, filed on Apr. 10, 2024, in the European Patent Office, the entire disclosure of which is incorporated herein by reference.

### BACKGROUND

### 1. Field

Aspects of embodiments of the present disclosure relate to a battery system with an improved end spacer.

### 2. Description of the Related Art

Recently, vehicles for transportation of goods and peoples have been developed that use electric power as a source for motion. Such an electric vehicle is an automobile that is propelled, permanently or temporarily, by an electric motor using energy stored in rechargeable batteries. An electric vehicle may be solely powered by batteries (a so-called Battery Electric Vehicle or BEV) or may include a combination of an electric motor and, for example, a conventional combustion engine (a so-called Plugin Hybrid Electric Vehicle or PHEV). BEVs and PHEVs use high-capacity rechargeable batteries that are designed to provide power for propulsion over sustained periods of time.

Generally, a rechargeable (or secondary) battery cell includes an electrode assembly including a positive electrode, a negative electrode, and a separator interposed between the electrodes. A solid or liquid electrolyte allows for movement of ions during charging and discharging of the battery cell. The electrode assembly is located (or arranged) in a casing and electrode terminals, which are positioned on the outside of the casing, establish an electrically conductive connection to the electrodes. The casing may have, for example, a cylindrical or rectangular shape.

A battery module is generally formed of a plurality of battery cells connected together in series or in parallel. For example, the battery module is formed by interconnecting the electrode terminals of the plurality of battery cells in a number and configuration depending on a desired amount of power and to provide a high-power rechargeable battery.

Battery modules can be constructed in either a block design or in a modular design. In the block design, each battery cell is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage.

A battery pack is a set of any number of (usually identical) battery modules or single battery cells. The battery modules, or the respective battery cells, may be configured in a series, parallel, or a mixture of both to provide the desired voltage, capacity, and/or power density. Components of a battery pack include the individual battery modules and interconnects, which provide electrical conductivity between the battery modules.

The battery cells of a battery pack may be arranged to form a cell stack by stacking the battery cells onto each other or by arranging the battery cells in a row. Neighboring battery cells in a cell stack may be distanced (or spaced apart) from one another via cell spacers. The cell stack may be placed inside a cell stack frame delimiting the battery cells to the outside. Pressure (e.g., predefined pressure) is exerted onto the battery cells by the cell stack frame to compensate for possible production tolerances and swelling of the battery cells to ensure optimal operation of the battery cells over their lifetime.

Conventional battery systems generally include cell stack frames with end plates exerting pressure onto the cell stack, in some cases via an end spacer, with a rigid linear or progressive elastic pressure characteristic. Such rigid frameworks may be susceptible to length or positioning deviations because a small displacement may cause a large (or steep) increase or decrease of force applied onto the cell stack, which may, in turn, reduce the performance of the call stack. To mitigate this, very precise and, therefore, expensive production tolerances have to be met or other costly and intricate ways of adjusting the cell stacks pre-tension via positioning of the end plate during assembly have to be implemented. Such end plates may not be able to ensure that the right amount of pressure is applied to the cell stack over its entire lifetime.

### SUMMARY

The present disclosure is defined by the appended claims and their equivalents. The description that follows is subject to this limitation. Any disclosure lying outside the scope of the claims and their equivalents is intended for illustrative as well as comparative purposes.

Embodiments of the present application provide a battery system with an improved cell stack frame that ensures correct pressure conditions for optimal operation of the battery cells over their entire lifetime.

According to an embodiment of the present disclosure, a battery system includes: a cell stack including a plurality of arranged battery cells; and a cell stack frame accommodating the cell stack and including comprising an end plate exerting pressure onto the cell stack; and a deformable end spacer arranged between the cell stack and the end plate. The deformable end spacer is compressed by the pressure exerted by the end plate and includes: parallel plate elements; and a metal foam and/or a metal honeycomb structure arranged between the plate elements. The plate elements have a different material composition than the metal foam and/or the metal honeycomb structure, the metal foam is an aluminum foam and/or the metal honeycomb structure is an aluminum honeycomb structure, and the plate elements are steel plate elements.

According to another embodiment of the present disclosure, the end spacer, under nominal compression, has a thickness that may be substantially the same as the thickness of one of the battery cells.

According to another embodiment of the present disclosure, the metal foam has a porosity in a range of about 80% to about 90%, for example, about 85%.

Another embodiment of the present disclosure refers to an electric vehicle including the battery system as described above.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic top view of a battery system according to an embodiment.

FIG. 2 is a schematic side view of an end spacer of the battery system shown in FIG. 1.

FIGS. 3A-3C are three schematic top views of battery systems having different cell stack lengths.

FIG. 4 is a diagram showing a force to elongation (e.g., displacement) ratio for the battery system according to an embodiment.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be only briefly described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

As used herein, the term “substantially,” “about,” and similar terms are used as terms of approximation and not as terms of degree and are intended to account for inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to an embodiment of the present disclosure, a battery system includes a plurality of battery cells, for example, prismatic or pouch type battery cells. The battery cells are arranged to form a cell stack, for example, by stacking the battery cells onto each other or by arranging the battery cells in a row. Cell spacers may be disposed in-between adjacent or neighboring battery cells. Thus, neighboring battery cells of the cell stack may be distanced (or spaced) from one another via a cell spacer. The cell stack may form one or more battery packs.

The cell stack is disposed inside a cell stack frame. The cell stack frame includes at least one end plate that exerts pressure onto the cell stack. The cell stack frame may include two end plates and two side walls connecting the end plates, and one or both of the end plates may exert pressure onto the cell stack. The cell stack arranged inside the cell stack frame may, thus, be delimited from four sides by the end plates and side walls. The cell stack frame may further include a top cover and a bottom cover such that the cell stack may be delimited from all six sides. The end plate may be fixed to the side walls (and/or the top cover and bottom cover), for example, by being riveted or screwed. The end plate may be rigid, for example, non-deformable. The cell stack frame may delimit the cell stack to an outside, that is, to an external environment of the cell stack. The end plate may form an outer delimitation of the cell stack frame. Also, the other end plate and/or the side walls may form the outer delimitation of the cell stack frame. In other words, the cell stack frame, for example, the two end plates and two side walls, may delimit an interior space of the cell stack frame from the exterior environment, with the cell stack arranged in the interior space.

A deformable end spacer is arranged between the cell stack and the end plate. Thus, the deformable end spacer is arranged inside the interior space delimited by the cell stack frame. The end plate, in the mounted position, exerts pressure onto the cell stack via the deformable end spacer, thereby compressing, for example, deforming, the deformable end spacer. The end plate may exert pressure onto the cell stack via the deformable end spacer while being supported or fixed to other parts of the cell stack frame, for example, to the side walls. The cell stack frame, thus, provides pre-tensioning of the cell stack. In an embodiment, the cell stack frame includes two end plates at opposite ends of the cell stack frame, and such deformable end spacer is disposed on both ends (e.g., at opposite ends) of the cell stack between the respective end of the cell stack and the respective end plate. The deformable end spacer may have a shape, such as a rectangular shape, corresponding to a shape of an interior space of the cell stack frame that accommodates the cell stack.

The deformable end spacer includes two parallel plate elements and one or more of a metal foam and a metal honeycomb structure. For example, the deformable end spacer includes a metal foam, a metal honeycomb structure, or a metal foam and a metal honeycomb structure. For example, a first layer of the deformable end spacer may include, or may consist of, the metal foam, and a second layer of the deformable end spacer may include, or may consist of, the metal honeycomb structure. A metal foam is a material or structure consisting of a solid metal with gas-filled pores forming a large portion of the volume. The metal foam may have an open-cell structure in which the pores may be interconnected or a closed-cell structure in which the pores may be closed/sealed. The metal foam and the metal honeycomb structure may exhibit an deformation characteristic that makes them suitable for use as an end spacer as described below.

Due to the metal foam/metal honeycomb structure, the deformable end spacer is configured to be, at lower compression forces, elastically deformed and, at higher compression forces, plastically deformed. The metal foam and the metal honeycomb structure may exhibit a suitable deformation characteristic for ensuring that the pressure onto the cell stack, that is, the compression force acting onto the cell stack, is substantially constant over the lifetime of the cell stack. Thus, in contrast to conventional battery systems, which may exhibit a rigid linear or progressive elastic pressure characteristic, the battery system according to embodiments of the present disclosure has, due to the deformable end spacer, a constant deformation characteristic in the relevant force range. For example, the end plate, due to the deformable end spacer, may exert constant compression force onto the cell stack in the relevant pre-tensioning force range for prismatic or pouch type cells. Inevitable tolerances for both the elements of the cell stack as well as the elements of the cell stack frame can be compensated for by the inherent deformation ability of the deformable end spacer, which may eliminate the need for additional shimming or other adjustment work during cell stacking. Further, any swelling (which may be due to, for example, ageing) of the battery cells of the cell stack may also be compensated for. Also, loads which may occur during accidents may be compensated. Due to said tolerances and swelling, a length of the cell stack may vary. However, due to the deformable end spacer, the end plate may exert substantially the same pressure onto the cell stack independent of the length of the cell stack. Thus, the cell stack may be maintained in the optimum range of pressure for peak performance, ensuring reliable and safe operation through all its life cycle until end of life. Thus, in summary, the battery system is configured to compensate for production tolerances as well as swelling forces/displacements of the battery cells over the lifetime of the battery system because the deformable end spacer is configured to maintain a substantially constant pressure.

The metal foam may be an aluminum (Al) foam. The metal honeycomb structure may be an aluminum (Al) honeycomb structure. Thus, the metal foam and/or metal honeycomb structure includes, or may consist of, aluminum. The metal foam may be a metal alloy foam, for example, the metal foam may be made of a metal alloy. The metal alloy may include aluminum. The metal foam may be a composite metal foam made from a combination of hollow metal spheres and a metallic matrix surrounding the spheres. Aluminum may be suitable because it is lightweight.

In some embodiments, the end spacer includes two parallel plate elements, and the metal foam and/or metal honeycomb structure is disposed in between the plate elements. For example, the metal foam and/or metal honeycomb structure is sandwiched between the two plate elements. A first plate element may face the end plate, and the second plate element may face the cell stack. The plate elements may have the same material composition as the metal foam and/or metal honeycomb structure, for example, the plate elements may include, or may consist of, aluminum. The plate elements may be rigid, for example, non-deformable. The plate elements may provide suitable contact surfaces for the end plate and the cell stack. For example, the plate elements may contact the end plate and cell stack over a large area such that the force/pressure exerted by the end plate is uniformly transferred. For example, the force/pressure exerted by the end plate may be uniformly transferred from the end plate to the first plate element, from the first plate element to the metal foam and/or honeycomb structure, from there to the second end plate, and finally from the second end plate to the cell stack. Nevertheless, the metal foam and/or metal honeycomb structure may exhibit their intended deformation characteristic.

The plate elements have a different material composition than the metal foam and/or metal honeycomb structure. For example, the plate elements may be steel plate elements, while the metal foam and/or metal honeycomb structure may include or may be made of aluminum. The plate elements having a different material composition than the metal foam and/or metal honeycomb structure may provide for a more stable structure while maintaining the intended deformation characteristic.

According to an embodiment, the end spacer, under nominal compression, has a thickness (e.g., an extension along a stacking axis) that is substantially the same as the thickness of one of the battery cells. Nominal compression may refer to a compression value or range that the end plate exerts onto the cell stack during nominal operation conditions, for example, before any age-related swelling of the battery cells. Adapting the thickness of the end spacer to the thickness of the battery cells may ensure the intended deformation characteristic. For example, thicker battery cells may increase more in thickness than thinner battery cells due to age-related swelling. Therefore, a thicker end spacer may be provided to support the thicker battery cells and a thinner end spacer to support the thinner battery cells.

According to an embodiment, the metal foam has a porosity in a range of about 80% to about 90%, for example, about 85%. Such a porosity range or values may be suitable to provide the intended deformation characteristic.

The present disclosure also pertains to an electric vehicle including a battery system as described herein.

According to an embodiment of the present disclosure, a method for assembling a battery system as described herein may be provided. Therein, in a first embodiment, the cell stack frame may be provided with the end plate placed in its fixture/mounting position and the deformable end spacer disposed adjacent to the end plate. For example, the end plate may be in the fixture/mounting position and fixed to the side walls of the cell stack frame. Subsequently, the cell stack may be compressed and then be inserted, in its pre-compressed state, into the cell stack frame with the end plate already at its fixture/mounting position. The cell stack may then be released and may expand until its contacts the deformable end spacer such that the end plate exerts pressure onto the cell stack via the deformable end spacer. In a second embodiment, the cell stack frame may be provided without the end plate placed in its fixture/mounting position. The cell stack may be inserted into the cell stack frame without pre-compression. Subsequently, the deformable end spacer may be placed next to the cell stack, and then, the end plate may be placed in its fixture/mounting position thereby compressing the cell stack, that is, exerting pressure onto the cell stack via the deformable end spacer.

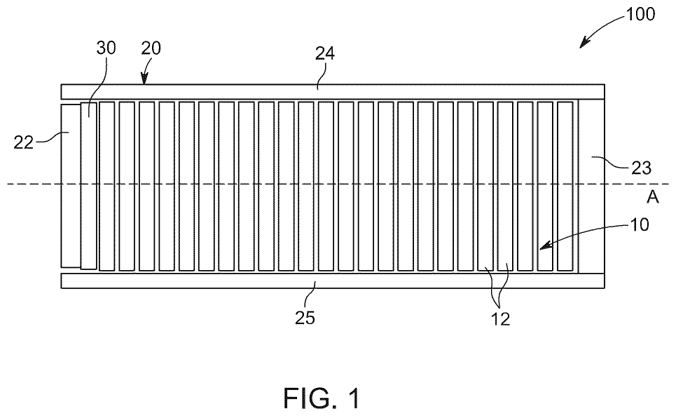

FIG. 1 is a schematic top view of a battery system 100 according to an embodiment. The battery system 100 includes a plurality of battery cells 12 arranged to form a cell stack 10 and a cell stack frame 20 accommodating the cell stack 10. The battery cells 12 are stacked (or arranged) along a stacking axis A.

The cell stack frame 20 includes two end plates 22, 23 and two side walls 24, 25 connecting the end plates 22, 23. The end plates 22, 23 and side walls 24, 25 delimit the cell stack 10 from four sides as shown in, for example, FIG. 1. The cell stack frame 20 may further include a top cover and a bottom cover to completely encase the cell stack 10. The end plates 22, 23 may be fixed to the side walls 24, 25 on opposite sides via, for example, screws or rivets.

A deformable end spacer 30 is placed between the end plate 22 and the cell stack 10. The deformable end spacer 30 has a rectangular shape corresponding to a shape of an interior space of the cell stack frame 20 that accommodates the cell stack 10.

Due to production tolerances of the battery cells 12 and possibly of any cell spacers (if present) arranged in between the battery cells 12, the length of the cell stack 10 may vary. For example, during production, not all produced cell stacks 10 will have the same length. Also, the battery cells 12 of the cell stack 10 may swell due to ageing, thereby expanding along the axis A and, thus, increasing the length of the cell stack 10. The cell stack frame 20, according to embodiments of the present disclosure, may compensate for these different lengths of the cell stack 10 because of the deformable end spacer 30.

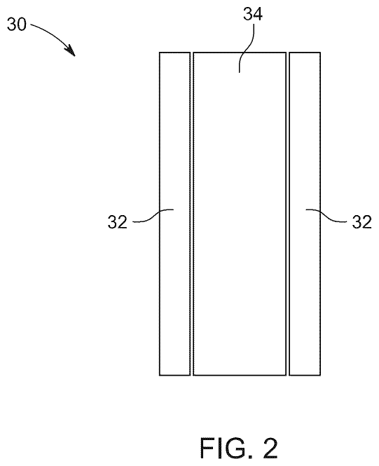

Referring to FIG. 2, the deformable end spacer 30 includes two parallel plate elements 32 and a metal foam 34 disposed in between the plate element 32.

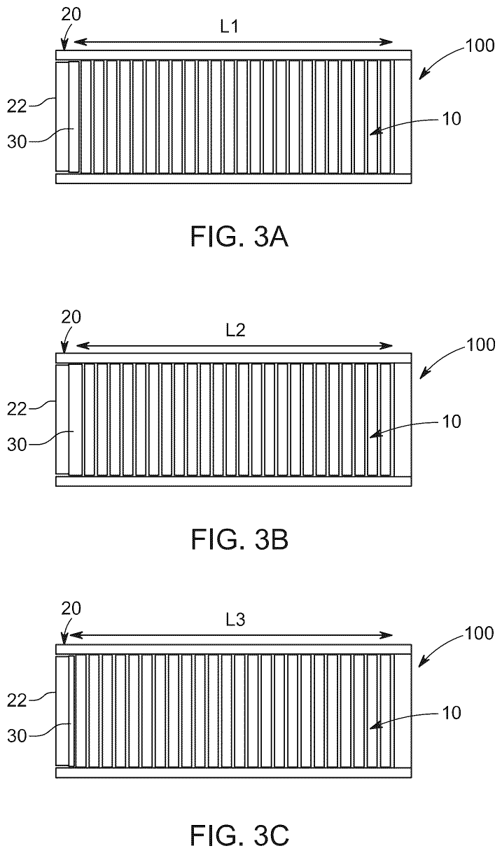

As shown in FIGS. 3A-3C, the deformable end spacer 30 is deformed to different degrees depending on the cell stack length. In FIG. 3A, the cell stack 10 has a first length L1, in FIG. 3B, the cell stack 10 has a second length L2, and in FIG. 3C, the cell stack 10 has a third length L3. The second length L2 may be a minimal length, the third length L3 a maximum length, and the first length L1 a nominal length such that L3>L1>L2. For the cell stack 10 having the minimal length L2, the deformable end spacer 30 is only slightly deformed (see, e.g., FIG. 3B). For the cell stack 10 having the maximum length L3, the deformable end spacer 30 is heavily (or greatly) deformed (see, e.g., FIG. 3C). For the cell stack 10 having the nominal length L1, the deformable end spacer 30 is moderately deformed (see, e.g., FIG. 3A). The end plate 22 may exert substantially the same pressure onto the cell stack 10 independent of the length of the cell stack 10 due to the deformable end spacer 30. The battery system 100 with its deformable end spacer 30 may, thus, be configured to ensure the correct pressure conditions for optimal operation of the battery cells 12 over their entire lifetime.

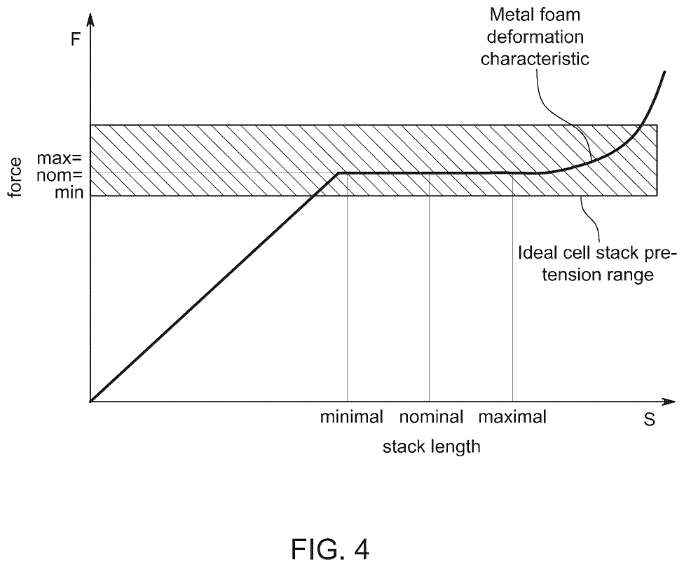

In contrast to conventional battery systems, which may exhibit a rigid linear or progressive elastic pressure characteristic, the battery system according to embodiments of the present disclosure, has, due to the deformable end spacer 30, at lower compression forces, an elastic deformation characteristic and, at higher compression forces, a plastic deformation characteristic. The plastic deformation characteristic has a flat force-displacement-inclination in the relevant pre-tensioning force range for prismatic or pouch type cells as shown in FIG. 4.

FIG. 4 is a diagram showing a force F to elongation (e.g., displacement) s ratio for the deformable end spacer 30 including the metal foam. As shown, the exerted force F increases linearly (e.g., the deformable end spacer 30 undergoes elastic deformation) with the elongation s (and, thus, stack length L) in a first section at lower forces and stays constant (e.g., the deformable end spacer 30 undergoes plastic deformation) in a second section at higher forces. The force (and, thus, the pressure) exerted by the end plate 22 is regulated by the deformable end spacer 30 such that the force is maintained within a window or range for an ideal cell stack pre-tension for the different cell stack lengths shown in FIGS. 3A-3C.

Thus, the end plate 22 may, due to the deformable end spacer 30, exert a constant compression force onto the cell stack 10 and is therefore configured to compensate for production tolerances as well as swelling forces/displacements of the battery cells over the lifetime of the battery system. The end plate 22 and deformable end spacer 30 is designed such that the min-max cell stack tolerances are in the flat plateau area of the force/deflection curve, as shown in FIG. 4. The flat plateau may be provided by plastic deformation of the metal foam until the air is almost entirely pressed out of the foam. Then, the foam may get stiffer and stiffer such that the force rises increasingly with the deformation. Thus, the cell stack 10 may be maintained in the optimum range of pressure for peak performance, ensuring reliable and safe operation through all its life cycle until end of life.

Some Reference Symbols

| | | | |
|---|---|---|---|
| 10 | cell stack | 12 | battery cells |
| 20 | cell stack frame | 22 | end plate |
| 23 | end plate | 24 | side wall |
| 25 | side wall | 30 | deformable end spacer |
| 32 | plate elements | 34 | metal foam |
| 100 | battery system | A | axis |

What is claimed is:

1. A battery system comprising:
a cell stack comprising a plurality of arranged battery cells; and
a cell stack frame accommodating the cell stack, the cell stack frame comprising an end plate exerting pressure onto the cell stack; and
a deformable end spacer arranged between the cell stack and the end plate, the deformable end spacer being compressed by the pressure exerted by the end plate, the deformable end spacer comprising:
parallel plate elements; and
a metal foam and/or a metal honeycomb structure arranged between the plate elements,
wherein the plate elements have a different material composition than the metal foam and/or the metal honeycomb structure,
wherein the metal foam is an aluminum foam and/or the metal honeycomb structure is an aluminum honeycomb structure, and
wherein the plate elements are steel plate elements.

2. The battery system as claimed in claim 1, wherein the deformable end spacer, under nominal compression, has a thickness that is the same as the thickness of one of the battery cells.

3. The battery system as claimed in claim 1, wherein the metal foam has a porosity in a range of 80% to 90%, for example about 85%.

4. The battery system as claimed in claim 3, wherein the metal foam has a porosity of 85%.

5. An electric vehicle comprising the battery system as claimed in claim 1.
